(19) United States
(12) Patent Application Publication
(10) Pub. No.: US 2002/0191588 A1
(43) Pub. Date: Dec. 19, 2002

(54) Integrated circuit and packet switching system

(75) Inventor: Stewart D. Personick, Bernardsville, NJ (US)

Correspondence Address: AKIN, GUMP, STRAUSS, HAUER & FELD, L.L.P., ONE COMMERCE SQUARE, SUITE 2200, 2005 MARKET STREET, PHILADELPHIA, PA, 19103, US

(73) Assignee: Drexel University, Philadelphia, PA

(21) Appl. No.: 09/970,342

(22) Filed: Oct. 3, 2001

Related U.S. Application Data
(60) Provisional application No. 60/297,824, filed on Jun. 13, 2001.

(51) Int. Cl. H04L 12/66

(52) U.S. Cl. 370/352; 370/401

(57) ABSTRACT

An integrated packet switching and circuit switching network for transporting data received from a plurality of sources across the network as one of packet switched packets and circuit switched packets. The network comprises one or more input transitional switches, one or more output transitional switches, and one or more one core switches, including a packet router and a time divided-space switch, connected between the input transitional switch and the output transitional switch by time division multiplexed communication links. The communication links transport the received data in a plurality of fixed length time slots occurring within a periodically repeating cycle signal. Packet switched packets received at the core switch are switched by the router according to information within a header in each packet switched packet. Circuit switched packets received at the core switch are time-division-space switched according to an allocation of specific ones of the time slots.

### CROSS-REFERENCE TO RELATED APPLICATIONS

This application claims the benefit of Provisional Application No. 60/297,824, filed Jun. 13, 2001 entitled “Integrated Deterministic and Statistical Packet Switching System”, which is hereby incorporated by reference in its entirety.

### BACKGROUND OF THE INVENTION

This invention relates to switching systems and more particularly, to switching systems that provide both packet switching service and circuit switching service.

Telecommunications networks employ a variety of switching and multiplexing techniques to enable metallic cable, optical fiber and radio communications media to be simultaneously, or nearly simultaneously shared by traffic originating from different sources and/or terminating at different destinations.

There are, currently, two basic switching techniques commonly used in telecommunications networks to allow telecommunications traffic to share the communications media. One technique is commonly referred to as circuit switching. The other technique is commonly referred to as packet switching. In circuit switching, individual sources of traffic reserve a portion of the communication capacity of each of a fixed set of communication links between a source and a destination for a period of time determined by the communication requirements of the communicating entities that have requested the establishment of the circuit. The reserved capacity on each pre-established link in the set is equal to, or greater than a specific capacity required for the end-to-end “circuit”. Reserving the circuit from the source to the destination guarantees that the full reserved capacity of each communication link that is a part of the circuit will always be available for traffic between the source and the destination at least during the reserved period. Further, because the traffic passing through the pre-established communication links, and through the pre-established circuit-switched connections of the switches joining the communication links, that comprise a circuit utilize paths and associated network resources that are reserved and held constantly available for the duration of each circuit's existence, traffic delay through the each circuit, from source to destination, is essentially constant; and, in particular, traffic traveling an established circuit from the source to the destination does not experience unpredictable delays associated with congestion caused by competition for resources from other traffic traveling through the network. However, during the time period that the portions of the communication links that comprise a circuit are reserved, these portions of the communication links may not be utilized by other traffic, even when the capacity of these reserved portions of the communication links is not being fully utilized. Thus, portions of the network capacity may be under-utilized, while other portions are overloaded.

In conventional packet switching, traffic is broken down into packets of data, each containing some number of bytes of “payload”, and each containing a destination address. Communications links are shared by interleaving, on a statistical, “first come, first served” basis, the data packets from different sources. The packets of data travel from switching node to switching node on a “space available” basis. When a packet arrives at a switching node within the network it is placed in a buffer (a temporary storage subsystem), and waits for available space on an outgoing communications link that will take the packet toward its final destination. Packet switching does not require coordination or pre-assignment of capacity (space) on the links that a packet will use in traveling from its source to its destination. Further, packet switching (in theory) provides high utilization of the capacity of the communications media. However, packet switching leads to unpredictable delays while packets wait in buffers for space to become available on outgoing links. In addition, if too many packets arrive at a switching node in a given interval of time, the buffers used to temporarily store packets may become full, resulting in packets being discarded.

Various telecommunications network concepts have been developed which attempt to provide the high utilization of the communications media afforded by packet switching simultaneously with the fixed network transit delay time and guaranteed transit afforded by circuit switching. For example, local area networks composed of daisy chained links between devices conforming to IEEE Standard 1394 allow for a portion of the capacity of the communications media to be allocated to circuit switched traffic that is in the form of a constant rate sequence (stream) of bytes; and the remainder of the capacity to be allocated to packet switched traffic. Similarly, local area networks conforming to the Fiber Distributed Data Interface (FDDI) allow traffic to be segregated into: (1) a synchronous class (sometimes called isochronous traffic) in which traffic, in the form of a constant rate sequence of bytes, that has been granted a requested reservation of a portion of the synchronous capacity is guaranteed timely access to the network, and transit across the network with a fixed (unchanging) transit time, and (2) an asynchronous (“space available”) class in which the delay encountered by traffic, in the form of packets attempting to access and transit the network, is unpredictable. Each node on the network is allocated a prescribed set of time slots, from among a periodically repeating sequence of time slots, to transmit its synchronous traffic.

While IEEE Standard 1394 and FDDI-compliant local area networks combine both circuit switching and packet switching methodologies within the same network, these two networking technologies do not provide a prescribed mechanism for recognizing packets arriving at an intermediate node of the network (between the source and destination nodes) as packets that require deterministic (fixed, guaranteed delay) transport, and for interleaving such packets with other packets not requiring deterministic transport. Furthermore, those two local area technologies do not include prescribed mechanisms or capabilities for constructing networks whose switching nodes may include an arbitrary number of inputs and output links and the mechanism in the switching nodes for time-divided-space switching. Furthermore, these two local area networking technologies do not provide a prescribed mechanism for placing a packet switched (space-available transport) packet in a time slot that has been reserved for circuit switched (fixed, guaranteed transport delays) packets, but which is not needed by such packets.

Frame relay, another packet switching networking technology, combines the statistical multiplexing characteristics of packet switching with some of the desirable characteristics of circuit switching. Frame relay packets (called frames) are transported through a network by interpreting an abbreviated address in the header of each frame, at each frame relay switch; and using that abbreviated address to determine the outgoing link over which that packet (frame) should be forwarded. In contrast to conventional packet switching in which the address in the header is the ultimate destination of the packet, the abbreviated address in the frame relay header is, in effect, the address of the next switch in the end-to-end communication path. A specific path through a frame relay network is known as a Permanent Virtual Circuit (PVC). The word “permanent” signifies that such paths (circuits) are generally established and kept in place for long periods of time. The routing data that must be stored in each switch, to enable each switch to determine which outgoing link an arriving packet should be forwarded over for implementing a PVC, is created and loaded into the switches when that a PVC is set up. In addition, frame relay networks do not attempt to detect and repair damage that may occur to a packet that has traversed a link in the network. Such damage is detected and dealt with on an end-to-end basis through the efforts of the source and destination nodes. Not performing error detection/correction within the network eliminates the delays that are experienced by packets that are individually checked for damage, on a link-by-link basis, in some types of packet switched networks. However, while frame relay reduces the processing and the delay associated with forwarding each frame (packet) of data at a switching node, frame relay does not provide a guaranteed throughput or a fixed, guaranteed time delay for the packets (frames) that are traversing a PVC, since the delay time though each switch, experienced by each packet using a given PVC to traverse the network, is still subject, in general, to the availability of space for that packet on each of the shared links of the network that comprise the circuit. Furthermore, frame relay provides no prescribed mechanism for creating reserved time slots or for using an unneeded reserved time slot (i.e., a time slot that can accommodate a frame) for the frames being transported on a space-available basis.

Another networking technology that can be used to create permanent virtual circuits that traverse a network is Asynchronous Transfer Mode (ATM). ATM employs 53-byte “cells” as the units of transport packaging. Generally, many cells are required to transport a single packet of data. Each cell contains a short address that is used by a switching node (at which that cell arrives) to determine which switching node it should be forwarded to. As in the case of frame relay, ATM does not provide a guaranteed throughput or a fixed, guaranteed time delay for the ATM cells that are traversing a PVC, since the delay time though each ATM switch, experienced by each cell using a given PVC to traverse the network, is still subject, in general, to the availability of space for that cell on each of the shared links of the network that comprise the circuit. Furthermore, ATM provides no prescribed mechanism for creating reserved time slots or for using a group of unneeded reserved time slots (i.e., a group of reserved, 53 byte time slots, that collectively can be used to transport a packet) for packets being transported on a space-available basis.

An approach is desirable to the switching of packetized telecommunications traffic which combines circuit switching with packet switching to obtain the guaranteed capacity and fixed delays associated with circuit switching and the efficient media utilization of packet switching.

### BRIEF SUMMARY OF THE INVENTION

Briefly stated, the present invention is an integrated packet switching and circuit switching network for transporting data received from a plurality of sources across the network as one of packet switched packets and circuit switched packets. The network comprises at least one input transitional switch receiving the data; at least one output transitional switch outputting the data; at least one core switch, including a packet router and a time divided-space switch, connected between the input transitional switch and the output transitional switch; and a plurality of time division multiplexed communication links coupling the at least one core switch to the at least one input transitional switch and to the at least one output transitional switch. The communication links transport the received data in a plurality of fixed length time slots occurring within a periodically repeating cycle signal having a fixed period. The packet switched packets received at the core switch are switched by the router according to information within a header in each packet switched packet. The circuit switched packets received at the core switch are time division-space switched according to an allocation of specific ones of the time slots.

The present invention further comprises a method for transporting data from an input transitional switch to an output transitional switch over a circuit switched circuit. The method comprises the steps of: allocating specific time slots on each one of selected communication links to the circuit; receiving the data at the input transitional switch; converting the received data to at least one fixed length packet having a length corresponding to one of the time slots; consigning each fixed length packet to one of the allocated time slots on each of the selected communication links; interchanging the time slot allocated to the at least one fixed length packet if there is contention for the time slot; and transporting each fixed length packet along the circuit from the one input transitional switch to the one output transitional switch.

The present invention further comprises a method for forming a circuit switched circuit for transporting circuit switched packets from an input transitional switch to an output transitional switch comprising the steps of: generating a circuit request at the input transitional switch for forming the circuit, wherein the circuit request identifies the output transitional switch and a throughput; determining a path from the input transitional switch to the output transitional switch based on the circuit request, wherein the path comprises a set of the communication links and core switches, and the communication links in the set provide the required throughput; and allocating specific time slots to the circuit on each of the communication links in the set for transporting each of the circuit switched packets over the circuit.

The present invention further comprises a method for transporting packet switched data from an input transitional switch to an output transitional switch comprising the steps of: receiving the packet switched data at the input transitional switch; determining if the received packet switched data have been designated for being transported via a circuit switched circuit; transporting the received packet switched data over the circuit as circuit switched packets if the received packet switched data have been so designated; and transporting the received packet switched data across the network to its designated destination as packet switched packets if the received packet switched data have not been so designated.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings, embodiments which are presently preferred. It should be understood, however, that the invention is not limited to the precise arrangements and instrumentalities shown.

In the drawings:

FIG. 1 is a functional block diagram of an integrated switching network in accordance with a preferred embodiment of the present invention;

FIG. 2 is a diagram of the timing on a time division multiplexed communication link;

FIG. 3 is a functional block diagram of a core switch in accordance with the preferred embodiment;

FIG. 4A is a functional block diagram of an input transitional switch in accordance with the preferred embodiment;

FIG. 4B is a functional block diagram of an output transitional switch in accordance with the preferred embodiment; and

FIG. 5 is a flow diagram showing steps for transporting packet switched packets and circuit switched packets in accordance with the preferred embodiment.

### DETAILED DESCRIPTION OF THE INVENTION

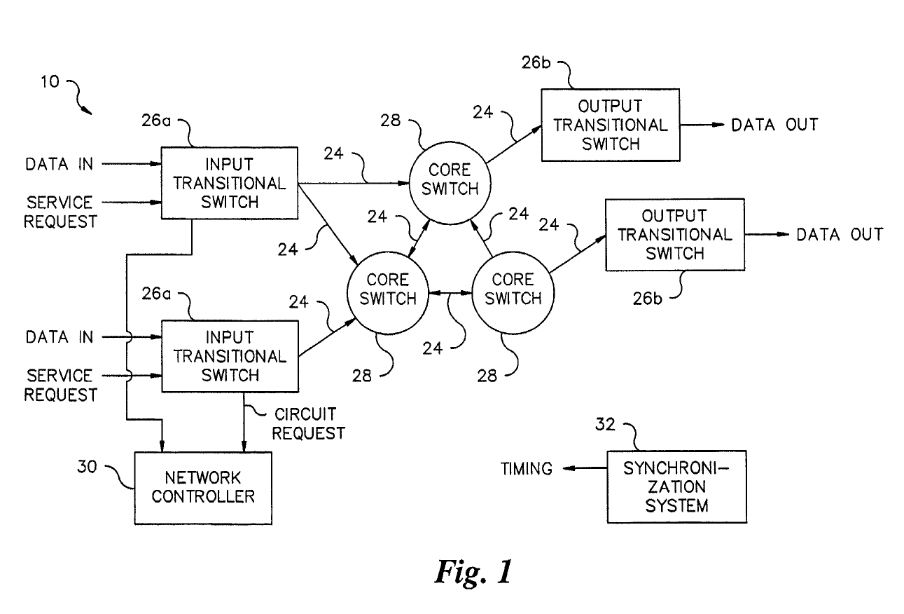

Referring to the drawings, wherein like numerals are used to indicate like elements throughout the several figures and the use of the indefinite article “a” may indicate a quantity of one, or more than one, of an element, there is shown in FIG. 1 a preferred embodiment of an integrated packet switching and circuit switching system 10 (hereinafter referred to as an integrated switching network 10) for transporting data from a plurality of sources as either packet switched packets or circuit switched packets.

As shown in FIG. 1, the integrated switching network 10 comprises one or more input transitional switches 26a for receiving data which are formatted according to one or more packet communication protocol standards, (referred to hereafter as packet switched data), in which routing and control information is included within each packet of the packet switched data. Each input transitional switch 26a also receives data which may not be in the format of packetized data. The input transitional switch 26a converts the received data to fixed length packets, designated as either packet switched packets or circuit switched packets, for transportation through the network 10, as further described below. Also shown in FIG. 1 are output transitional switches 26b which may reassemble the fixed length packets into the original format of the received data, for delivery of the received data to the destination of the data. As would be clear to those skilled in the art, the functions of the input transitional switches 26a and the output transitional switches 26b may be combined within one bidirectional (transitional) switch.

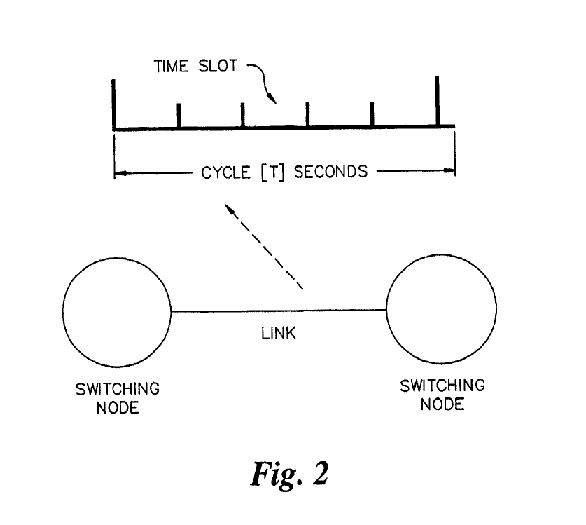

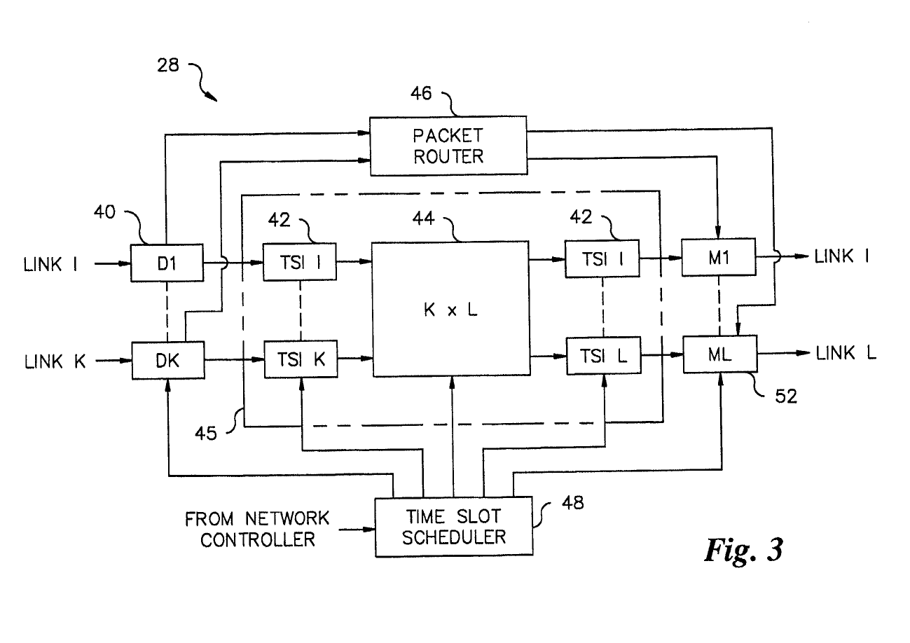

The integrated switching network 10 also comprises one or more core switches 28, each of which comprises both a packet router 46 (see FIG. 3) and a time divided-space switch 45 (see FIG. 3). The core switches 28 are connected to each other and to the transitional switches 26a, 26b by a plurality of time division multiplexed (TDM) communication links 24, which may employ either optical, wire, radio or other known media. Preferably, the time division multiplexed links 24 transport the data received by the integrated switching network 10 in one or more fixed length time slots occurring within a periodically repeating signal cycle of period T, having N time slots (see FIG. 2). The number N of time slots per cycle and the length of each time slot (i.e. the number of data symbols per slot) are design parameters that are selected for a particular network. Preferably, the period T, of each cycle, is fixed, regardless of the data rate of the TDM communication link 24, such data rate possibly being different for different links 24 within the network. Accordingly, the number of time slots per cycle is proportional to the data rate of the communications link 24.

Each of the fixed length packets generated by the input transitional switches 26a has a total length (measured in data symbols) that corresponds to the length of one of the time slots. However, the data received by an input transitional switch 26a may be of greater or lesser length than the length of the fixed length packets to which they are converted by the input transitional switch 26a. Preferably, the input transitional switch 26a segments the received data which have a length greater than the length of a time slot into two or more fixed length packets, each having the length of a time slot. When the segmented data has traversed the network, in the form or fixed length packets, it can be reassembled into its original form. Also, the input transitional switch 26a may employ encapsulation, whereby the received data which have a length shorter than the length of a time slot are padded with filler data, to make the length of the resulting fixed length packets equal to the length of one of the time slots. Terms such as segmentation, reassembly, and encapsulation are well known to those skilled in the art of packet switching.

Where the data received by the input transitional switch 26a is designated to be transported as packet switched packets, the input transitional switch 26a incorporates into each of the fixed length packets, a header which includes information for routing the fixed length packet through the integrated switching network 10. The fixed length packet header also contains information for the output transitional switch 26b to reassemble the fixed length packet switched packets into the original structure of the received data.

When the data is packet switched data, i.e. when the received data is formatted according to packet switching communication protocol standards, the header of each of the packet switched packets is preferably based on the network layer header of each packet of the received packet switched data. Datagrams (i.e., packets that are routed without the use of abbreviated, “virtual circuit” addresses) may also be formed by the input transitional switch 26a when the data received by the input transitional switch 26a is not formatted in accordance with packet network protocols. For example, information for creating the header within each of the datagrams may be provided to the input transitional switch 26b by a service request signal which designates that the received data is to be converted into the packet switched packets and routed through the network as packet switched packets. The service request may contain, for example, information such as the ultimate destination of the data, the amount of the data or the time duration of the data. Where the packet switched packets originate from data which are not originally packet switched data, the transitional switch 26b reassembles the packet switched packets to the format of the received data based on the information in the service request.

Data received by the input transitional switch 26a may also be transported through the network 10 as circuit switched packets. The data received by the input transitional switch 26a, to be transported as circuit switched packets, may be in the form of packets, such as a packet switched data form, or may be in the form of a continuous stream of bytes. The service request may designate that the received data be transported as circuit switched packets and may contain information such as the ultimate destination of the received data, the amount of the data or the time duration of the data. Alternatively, the input transitional switch 26a may determine that the received data is to be transported as circuit switched packets, as described below. Where the received data are designated to be transported as circuit switched packets by the service request, the transitional switch 26b reassembles the circuit switched packets to the format of the received data based on the information in the service request.

In the preferred embodiment, circuit switched circuits for transporting the circuit switched packets through the integrated switching network 10 are formed by a network controller 30 (see FIG. 1) reserving a quantity of the time slots in each of the TDM communication links 24 to each of the circuits. The network controller 30 maintains a database containing the quantity of the time slots which are reserved for each of the circuit switched circuits on each of the TDM communication links 24. In forming the circuits, the network controller 30 responds to circuit-establishment requests received from the various input transitional switches 26a. Preferably, the circuit requests describe the destination of the circuit switched packets (i.e. the designated output transitional switch 26b) and a required quality of service (e.g. minimum throughput or maximum latency). For example, an end system (e.g., a host computer) attached to the network 10 might request (via the service request) a connection to another end system (e.g., a server) which has a guaranteed minimum throughput or a controlled latency, which could only be satisfied by transporting all, or some portion of the traffic from the host computer through the integrated switching network 10 using circuit switching. In another example, an input transitional switch 26a might initiate the establishment of an additional circuit switched circuit (or more time slots per cycle on an existing circuit) to a designated output transitional switch 26b in order to accommodate an increasing volume of packet switched traffic arriving at the input transitional switch 26a, and destined for the output transitional switch 26b.

When the network controller 30 receives a circuit request, including the required value of the throughput, from the input transitional switch 26a, the network controller 30 converts the value of the throughput to an equivalent number of slots per cycle on each of the TDM communication links 24. The network controller 30 then examines the database in the network controller 30 for the TDM communication links 24 that can provide the required number of the time slots per cycle. Since the number of bytes in a time slot, and the number of cycles per unit time are the same for all links of the network, the number of time slots per cycle required to construct a circuit is the same for all links that will be used to construct that circuit. Preferably, if latency is not an issue, the network controller selects a path from the input transitional switch 26a to the designated output transitional switch 26b that provides the required throughput and which maintains the largest possible number of communication links 24 with unreserved time slots that can be used to create additional circuits or to transport packet switched packets. On the other hand, if minimum latency is required by the service request, the path with the minimum amount of latency is chosen. If at least one path satisfying the circuit request is determined, a set of the TDM communication links 24 is selected which provide the path, and a quantity of the periodically repeating time slots are reserved to the circuit on each one of the TDM communication links 24. If the network controller 30 cannot find a sufficient number of time slots on each of a set of links leading from the input transitional switch 26a to the designated output transitional switch 26b, the request to set up the new circuit switched circuit is denied.

Preferably, the network controller 30 is implemented as a centralized network management system that manages the transitional switches 26a, 26b and the core switches 28 and the reservation of the time slots on the communication links 24 of the integrated switching network 10. Alternatively, the network controller 30 can be implemented as a distributed network management system, with portions of its functionality distributed among the transitional switches 26a, 26b and the core switches 28. Alternatively, the network controller 30 can be implemented as a combination of centralized and distributed management systems, as would be apparent to a person skilled in the art of telecommunications networking.

Referring now to FIG. 3 there is shown a functional block diagram of a preferred embodiment of a core switch 28. Each core switch 28 comprises a packet router 46 for routing packet switched packets to a specific communication link 24 according to the header information in each of the packet switched packets, and a time divided-space switch 45 for switching circuit switched packets according to an allocation of each packet to a specific communication link 24 and a specific time slot in the specific communication link 24. The core switch 28 also includes demultiplexers 40, multiplexers 52 and a time slot scheduler 48, as described below.

Preferably, each core switch 28 also includes a demultiplexer 40 located at the termination of each one of the communication links 24 which are incoming to the core switch 28. Each demultiplexer 40 separates packets of the circuit switched traffic from packets of the packet switched traffic based on the time slot in which each packet is being received, if the packet is not within a reserved time slot. If a packet switched packet is within a reserved time slot (that was not needed to transport a circuit switched packet), the demultiplexer 40 recognizes a label in the packet header which designates the packet switched packet for packet switching. The packet switched packet is directed by the demultiplexer 40 to the packet router 46. The packet router 46 includes a routing table for determining the outgoing communication link 24 for the packet based upon destination information in the packet switched packet header. The routed packet switched packet is directed by the packet router 46 to a multiplexer 52 at the input of the outgoing communication link 24. The multiplexer 52 combines the circuit switched packets from the time divided-space switch 45 with the packet switched packet. The multiplexer inserts the packet switched packet into one of the time slots which is not reserved for the circuit switched packets or into a reserved time slot that is empty. In the latter case, a label is placed in the header of the packet switched packet that identifies the packet as a packet switched packet. The construction of packet routers are well known in the art of packet switching. As such the details of the structure and operation of the packet router 46 is not further described, for the sake of brevity.

Packets received at the demultiplexer 40 which are within a reserved time slot and which do not contain a label identifying the packet as a packet switched packet, are directed to the time divided-space switch 45. Each core switch 28 includes a time divided-space switch 45 for receiving the fixed length packets of the circuit switched data on each of the incoming communication links 24 and for allocating each of the plurality of the packets to a separate time slot on the correct outgoing communication link 24 in order manage the contention that occurs when two or more incoming links 24 contain packets destined for the same outgoing link 24. Even though there are enough time slots per cycle reserved on an outgoing link 24 to accommodate all of the fixed length packets that have reserved capacity on the outgoing link 24, the fixed length packets on the incoming links 24 may need to be assigned to time slots on the outgoing link 24 that are different from the time slots that the packets occupy on the incoming links 24. For example two fixed length packets on separate incoming communication links 24 might both arrive at the core switch in time slot number seven of their respective cycles. To direct both of the fixed length packets (for illustration) to the same outgoing link 24, it is necessary to move at least one of these incoming packets from time slot number seven to a different time slot on the outgoing link 24, since the packets cannot both occupy the same time slot in the same cycle on the same outgoing link.

Preferably, the time divided-space switch 45 is a “time-space-time” type of switch employing a plurality of time slot interchangers 42 and a time-divided space division switch 44. Alternatively, the time divided-space switch 45 could be constructed as a “space-time-space” type of switch. The construction of time divided-space switches, where time has been divided in units of individual bytes (rather than units of fixed length packets containing many bytes) are well known in the art of digital switching. One skilled in that art would recognize and understand the terms time-space-time, and space-time-space as they apply to digital switch design alternatives. The theory and methodology of that art can be directly applied to the construction of a time divided space switch, where time has been divided in units of fixed length packets, as it is here. As such, details of the structure and operation of the time divided space switch are not further described, for the sake of brevity.

The time divided-space switch 45 in each core switch is controlled by a time slot scheduler 48. The scheduler 48 is controlled by a circuit setup signal received from the network controller 30. Preferably, the setup signal, associated with the establishment of a circuit includes the quantity of the time slots per cycle to be reserved for the circuit switched packets arriving at the core switch 28 on each of the incoming communications links 24 and the quantity of the time slots to be reserved on the communications links 24 outgoing from the core switch 28. Preferably, the scheduler 48, autonomously allocates specific time slots to each circuit onto which the circuit switched packets are to be consigned by the time-divided-space switch 45, on each outgoing communication link 24 from the core switch 28, based on the quantity of the time slots that are reserved to each circuit by the setup signal. Following the allocation of the time slots to the outgoing communication links 24 originating at the input transitional switch 26a, and each core switch 28, the input transitional switch 26a and each core switch 28 in the path then transmit a designation of the specific time slots allocated on the respective outgoing communications link 24 to the next successive core switch 28 and the output transitional switch 26b in the path.

Alternatively, the specific time slots allocated to each circuit onto which the circuit switched packets are to be consigned by the time divided-space switch 45 on each outgoing communication link 24 from the core switch 28 may be determined by the network controller 30 and assigned to each scheduler 48 in the setup signal. For example, the network controller 30 may allocate the specific time slots by pairs of adjacent transitional/core switches 26a-28, 28-28, 28-26b and may transmit the time slot allocations to the scheduler 48 in each transitional switch 26a, 26b and each core switch 28. This might be desirable, for example, if a particular circuit must be configured with as little end-to-end delay as possible. In that case, the network controller 30 could constrain and orchestrate (for all of the switching nodes along a path) some or all aspects of the time divided-space switching that is done at each transitional switch 26a, 26b and each core switch 28 in order to minimize or constrain the cumulative delay associated with the time divided-space switching circuit setup process.

The scheduler 48 also determines to which time slots the packet switched packets are to be consigned on the outgoing communication links 24. Preferably, each packet switched packet is consigned by the multiplexer 52 to a first occurring empty time slot in the next cycle to be transmitted from the core switch 28 on the selected outgoing communications link 24, based on a signal from the scheduler 48. The first occurring empty time slot may be a time slot which has been reserved for circuit switched data but which is not occupied by data (i.e. empty). In the this case, the time slots that have been allocated to a circuit but are empty of circuit switched data are identified by the demultiplexer 40 in each core switch 28 by interpreting information within a designated field in the header of each of the fixed length packets which indicate whether or not the fixed length packet carries data received by the network 10 or is empty of data. Alternatively, the packet switched packet may be consigned to a time slot which has not been reserved for circuit switched data.

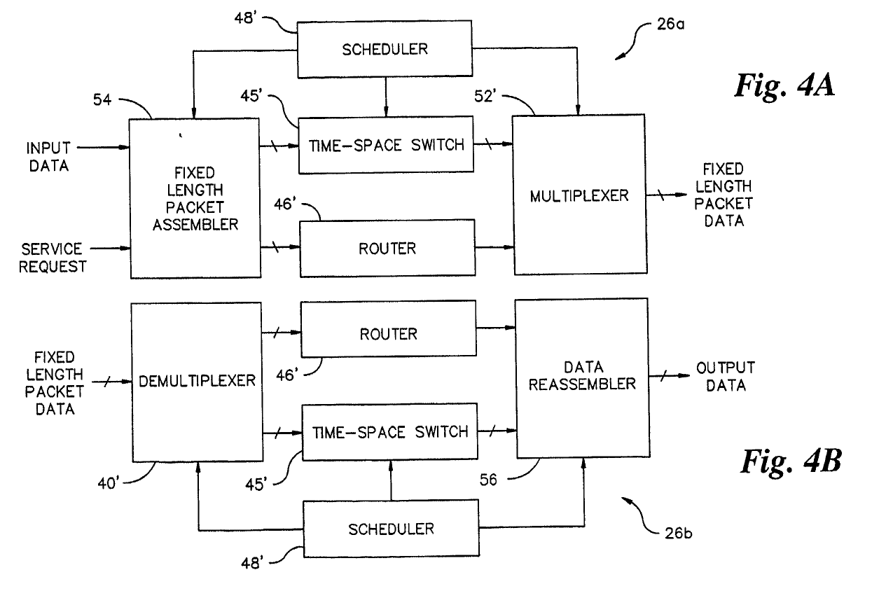

FIGS. 4A and 4B are functional block diagrams of an input transitional switch 26a and an output transitional switch 26b. Each input transitional switch 26a and each output transitional switch 26b comprise a packet router 46′, a time divided-space switch 45′, one or more demultiplexers 40′ (only one is shown), one or more multiplexers 52′ (only one is shown) and a scheduler 48′, which are substantially identical in structure and operation to the router 46, the time-space switch 45, the demultiplexers 40, the multiplexers 52 and the scheduler 48 utilized in the core switch 28. Accordingly, the previous description of the components of the core switch 28 applies equally to the corresponding components of the input transitional switch 26a and the output transitional switch 26b where the same components are described.

Each input transitional switch 26a also includes a fixed length packet assembler 54 and each output transitional switch 26b includes a data reassembler 56. The fixed length packet assembler 54, which utilizes methodologies such as packet segmentation, encapsulation, protocol conversion, and packet assembly to form the input data into the desired fixed length packets, and the data reassembler 56, which reconstructs the original data format from the fixed length packets that have traversed the network 10, are well known to those skilled in the art of packet switching. Accordingly, the details of the structure and the operation of the packet assmbler 54 and the data reassembler 56 are not further described, for the sake of brevity.

Preferably, the cycle and slot timing on the communication links 24 between transitional switches 26a, 26b and the core switches 28 are synchronized by a synchronization system 32 (FIG. 1). Preferably, the synchronization system 32 employs accurate clocks at each of the switches 26a, 26b, 28. Differential frequency drift between the clocks is preferably controlled by the use of phase locked timing and synchronization loops to extract correction signals from standard signals propagated from a network frequency standard. Other techniques such as pulse stuffing and data buffers may also be used. The methods for synchronizing time divided switches connected by TDM communication links are well known to those skilled in the art of digital switching and those skilled in the art of digital transmission. Accordingly, the details of the synchronization system are not repeated here, for the sake of brevity.

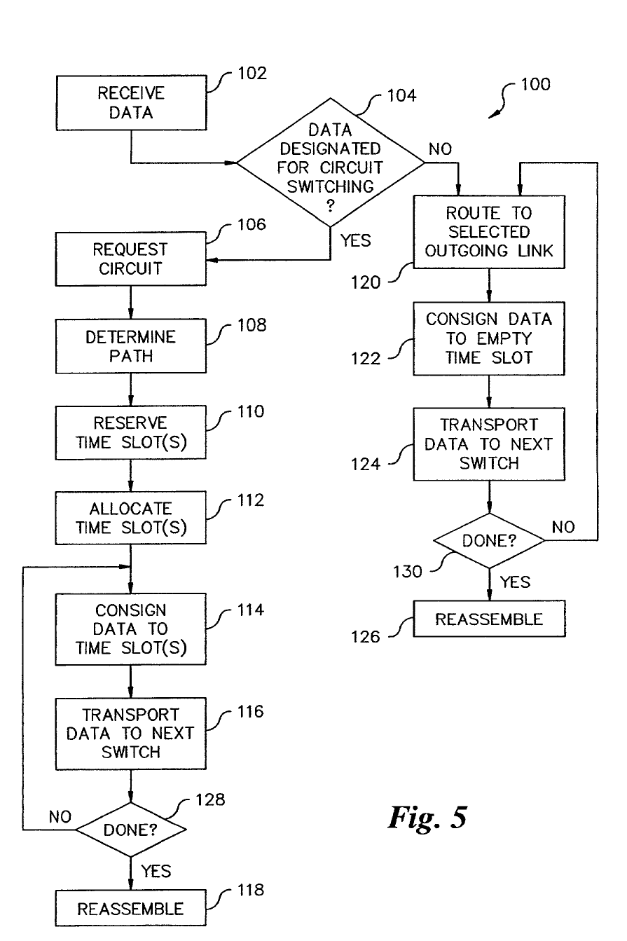

Referring now to FIG. 5 there is shown the preferred process 100 for transporting data received at an input transitional switch 26a to an output transitional switch 26b of the integrated switching network 10 via the communications links 24 and the core switches 28. Preferably, the data is transported to the output transitional switch 26b by converting the data to one or more fixed length packets, allocating each fixed length packet to one fixed length time slot within each cycle of a periodically repeating sequence of cycles on each communications link 24 to which the packet is assigned and transporting each packet via routers 46 or time divided-space switches 45 over the network 10. In step 102 the data is received by the input transitional switch 26a. Upon receiving the data, the input transitional switch determines whether the data is to be transported over the network 10 by circuit switching or by packet switching (step 104). The determination is made by the input transitional switch 26a based on information in a header of the data, by information in a separate service request or may be made by the input transitional switch 26b, based on traffic loading or throughput/latency requirements, as discussed above. The external service request may specify in the request for a circuit switched circuit, the total amount of data to be transported or the time duration for which the service request is to be effective. When the total amount of data has been successfully transported from the input transitional switch 26a to the output transitional switch 26b or the time duration of the request has expired, the circuit is torn down.

If the determination is made to transport the data by circuit switching, the input transitional switch 26a transmits a request to the network controller 30 for forming a circuit switched circuit extending from the input transitional switch 26a to the appropriate output transitional switch 26b (step 106). Preferably, the circuit request designates a destination output transitional switch 26b and a required throughput to be provided by the circuit. The request may also include a maximum latency time.

At step 108, the network controller 30 determines a path from the input transitional switch 26a to the designated output transitional switch 26b based upon information in the circuit request, and information accessible to the controller regarding the availability of unreserved network 10 resources. The path comprises a set of communication links 24 selected from among the communication links 24. Each of the communication links 24 is selected based on providing the required throughput. Preferably, as discussed above, the path is selected to provide the required throughput while maintaining the largest possible number of links with unreserved time slots that can be used to create additional circuits or to transport packet switched packets. The network controller 30 also identifies the input and output transitional switches 26a, 26b and core switches 28 which originate and terminate each of the communication links 24 in the set. Other algorithms for selecting the path for the circuit may be used, such as those which minimize the latency (time delay) across the network 10.

At step 110, the network controller 30 determines a quantity of time slots per cycle to be reserved on each communications link 24 to support the transporting of the circuit switched data over the circuit with the required throughput

In the preferred embodiment, the network controller 30 transmits a circuit setup signal to the input transitional switch 26a, the output transitional switch 26b and to the core switches 28 associated with the selected communication links 24 in the set. Preferably the circuit setup signal includes an identifier of the circuit, an identifier for a communication link incoming to the core switch 28, an identifier for a communication link outgoing from the core switch 28, a required quantity of time slots in the incoming communication link 24 to each core switch 28 and the output transitional switch 26b and a required number of time slots in the outgoing communication links 24 from the input transitional switch 26a and each core switch 28 in the set.

Preferably, the input transitional switch 26a and each core switch 28 in the set autonomously allocates specific time slots for each circuit to the selected outgoing communications links 24 originating at the input transitional switch 26a and the respective core switches 28 in the set, based on the required quantity of reserved time slots transmitted from the network controller 30 (step 112). The time slots which are allocated to each circuit in the input transitional switch 26a and each core switch 28 are used to program the time slot scheduler 48 which controls the time divided-space switches 45′, 45 in the input transitional switch 26a and in each core switch 28. Following the allocation of the specific time slots to the outgoing communication links 24 originating at the input transitional switch 26a, and each core switch 28, the input transitional switch 26a and each core switch 28 in the path transmit a designation of the specific time slots allocated to the respective outgoing communications link 24 to the next core switch 28 and to the output transitional switch 26b in the path. Alternatively, the network controller 30 may allocate the specific time slots by pairs to adjacent transitional/core switches 26a-28, 28-28, 28-26b as discussed above.

At step 114, the data received at the input transitional switch 26a which is designated for being transported over the circuit switched circuit as circuit switched packets is converted to one or more fixed length packets by the input transitional switch 26a. Preferably, each of the fixed length packets has a length equal to the length of a time slot. The fixed length packets are consigned to the allocated time slots within each of the cycles on each one of the communication links 24 belonging to the set. At step 116, the fixed length packets are transported from the input transitional switch 26a to a core switch 28, and from core switch 28 to core switch 28 by the action of the time divided-space switches 45′, 45 in the input transitional switch 26a and each of the core switches 28. The output transitional switch 26b collects the fixed length packets associated with the circuit switched data (step 128) and reassembles the received circuit switched data in accordance with information received from the network controller 30 (step 118).

Where the data received by the integrated switching network 10 is designated to be transported through the integrated switching network 10 by packet switching (step 104), the input transitional switch 26a converts the packet switched data to fixed length packets having a length corresponding to the length of each of the time slots. Each of the fixed length packets includes a packet label in a header that allows each transitional switch 26a, 26b and each core switch 28 to recognize that the fixed length packet is a packet to be packet switched. The header also includes information for routing the fixed length packets through the integrated switching network 10. The input transitional switch 26a and each core switch 10 include a routing table which routes each packet switched packet to a communication link 24 outgoing from the input transitional switch 26a and each core switch 28 based on comparing the routing information in the header with the routing table (step 120).

Preferably, each fixed length, packet switched packet is consigned by the routers 46, 46′, working in concert with the multiplexers 52, 52′, to a first occurring empty time slot in the next cycle to be transmitted from the input transitional switch 26a and each core switch 28 on the selected outgoing communications link 24 (step 122). The first occurring empty time slot may be a time slot which has been reserved for circuit switched data but which is not occupied by data, or it may be a time slot which has not been reserved for circuit switched data. At step 124, the fixed length packet switched packets are transported from core switch 28 to core switch 28 by the action of the router 46 in each of the core switches 28 (step 124). The fixed length packets eventually arrive at the output transitional switch 26b. The output transitional switch 26b collects the fixed length packets associated with the packet switched data (step 130) and reassembles the received packet switched data in accordance with information in the header of the fixed length packets (step 126).

As made clear in the disclosure, the present invention is an integrated switching network 10 for transporting data by either packet switching or by circuit switching, affording a user of the network 10 greater flexibility in transporting the data than either a packet switching network or a circuit switching network.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. An integrated packet switching and circuit switching network for transporting data received from a plurality of sources across the network as one of packet switched packets and circuit switched packets, the network comprising:
at least one input transitional switch receiving the data;
at least one output transitional switch outputting the data;
at least one core switch, including a packet router and a time divided-space switch, connected between the input transitional switch and the output transitional switch; and
a plurality of time division multiplexed communication links coupling the at least one core switch to the at least one input transitional switch and to the at least one output transitional switch, the communication links transporting the received data in a plurality of fixed length time slots occurring within a periodically repeating cycle signal having a fixed period, wherein the packet switched packets received at the core switch are switched by the router according to information within a header in each packet switched packet, and the circuit switched packets received at the core switch are time-division space switched according to an allocation of specific ones of the time slots.

2. The network according to claim 1, further including a network controller, the network controller managing the creation of a circuit for transporting the circuit switched packets from the input transitional switch to the output transitional switch in response to a circuit setup request signal, the circuit comprising a set of the time division multiplexed communication links selected from among the plurality of the time division multiplexed communication links and a required quantity of the time slots, the network controller selecting the communication links of the set and reserving the required quantity of the periodically repeating time slots on the selected communication links.

3. The network according to claim 2, wherein the input transitional switch and the core switch each autonomously allocates the specific time slots on each of the communication links in the set originating at the input transitional switch and the core switch based on the required quantity of the reserved time slots received from the network controller.

4. The network according to claim 2, wherein the network controller allocates the specific time slots on each of the communication links of the set based on the quantity of the time slots required to be reserved to the respective communication links, and data accessible to the network controller regarding the availability of specific time slots on those links.

5. The network according to claim 2, wherein the packet switched packets arriving at the core switch on an incoming communication link are consigned to one or more first occurring empty time slots on an outgoing communication link.

6. The network according to claim 2, wherein the packet switched packets arriving at the core switch on an incoming communication link are consigned to one or more of the time slots on an outgoing communication link that are not reserved.

7. The network according to claim 2, wherein the packet switched packets arriving at the core switch on an incoming communication link are consigned to one or more of the reserved time slots on an outgoing communication link that are empty.

8. The network according to claim 1, wherein each of the packet switched packets and the circuit switch packets have a fixed length corresponding to a length of the time slots, the packet switched packets and the circuit switched packets being formed from the received data by the input transitional switch.

9. The network according to claim 1, wherein the output transitional switch re-assembles the packet switched packets and the circuit switched packets into a format of the received data.

10. The network according to claim 1, wherein the time divided-space switch redirects each circuit switched packet in a first time slot on an incoming communication link to a second time slot on an outgoing communications link.

11. In an integrated packet switching and circuit switching network comprising a plurality of core switches, input transitional switches and output transitional switches, the core switches being connectable to each other and to the input transitional switches and the output transitional switches by a plurality of time division multiplexed communication links, each of the communication links transmitting/receiving a repeating cycle signal of a fixed period having a plurality of time slots, wherein a circuit switched circuit is formed between one of the input transitional switches and one of the output transitional switches by selecting a set of the communication links and the core switches for forming the circuit and by reserving to each of the selected communication links a quantity of the time slots, a method for transporting data from the one input transitional switch to the one output transitional switch over the circuit, the method comprising the steps of:
allocating specific time slots on each one of the selected communication links to the circuit;
receiving the data at the input transitional switch;
converting the received data to at least one fixed length packet having a length corresponding to one of the time slots;
consigning each fixed length packet to one of the allocated time slots on each of the selected communication links;
interchanging the time slot allocated to each fixed length packet if there is contention for the time slot; and
transporting each fixed length packet along the circuit from the one input transitional switch to the one output transitional switch.

12. In an integrated packet switching and circuit switching network comprising a plurality of core switches, input transitional switches and output transitional switches, the core switches being connectable to each other and to the input transitional switches and the output transitional switches by a plurality of time division multiplexed communication links, each of the communication links transmitting/receiving a repeating cycle signal of a fixed period having a plurality of time slots, a method for forming a circuit switched circuit for transporting circuit switched packets from one of the input transitional switches to one of the output transitional switches comprising the steps of:
generating a circuit request at the one input transitional switch for forming the circuit, the circuit request identifying the one output transitional switch and a throughput;
determining a path from the one input transitional switch to the one output transitional switch based on the circuit request, the path comprising a set of the communication links and the core switches, each of the communication links in the set providing the required throughput; and
allocating specific time slots to the circuit on each of the communication links in the set for transporting each of the circuit switched packets over the circuit.

13. The method according to claim 12, wherein the step of allocating the specific time slots on each of the communication links in the set comprises the step of transmitting a circuit setup signal to respective core switches in the set, the setup signal including an identifier of the circuit, an identifier for a communication link incoming to the respective core switch, an identifier for a communication link outgoing from the respective core switch, a required quantity of the time slots in the incoming communication link and a required quantity of the time slots on the outgoing communication link.

14. The method according to claim 13, wherein the step of allocating the specific time slots on each of the communication links in the set further comprises the step of the respective core switch in the set autonomously allocating the specific time slots on the incoming communication link and the outgoing communication link, based on the quantity of the time slots reserved to the incoming communication link and the quantity of the time slots reserved to the outgoing communication link.

15. The method according to claim 12, wherein the telecommunications network includes a network controller and wherein the step of allocating the specific time slots on each of the communication links in the set comprises the step of the network controller transmitting a circuit setup signal to respective core switches in the set, the signal including an identifier of the circuit, an identifier for a communication link incoming to the respective core switch, an identifier for a communication link outgoing from the respective core switch, an allocation of the specific time slots on the incoming communication link and an allocation of the specific time slots on the outgoing communication link.

16. The method according to claim 12, wherein the circuit request includes a total amount of the data to be transferred by the circuit, the method further including the step of tearing down the circuit when the total amount of the data has been successfully transported from the input transitional switch to the output transitional switch.

17. In an integrated packet switching and circuit switching network comprising a plurality of core switches, input transitional switches and output transitional switches, each core switch including a routing table and being connectable to other core switches and to the input transitional switches and the output transitional switches by a plurality of time division multiplexed communication links, each of the communication links transmitting/receiving a repeating cycle signal of a fixed period having a plurality of time slots, wherein a circuit switched circuit is formed between one of the input transitional switches and one of the output transitional switches by selecting a set of the communication links and by reserving to each of the communication links in the set a quantity of the time slots, a method for transporting packet switched data from the one input transitional switch to the one output transitional switch comprising the steps of:
receiving the packet switched data at the input transitional switch;
determining if the received packet switched data have been designated for being transported via the circuit switched circuit;
transporting the received packet switched data over the circuit as circuit switched packets if the received packet switched data have been so designated; and
transporting the received packet switched data over the circuit as packet switched packets if the received packet switched data have not been so designated.

18. The method according to claim 17, wherein if the received packet switched data have not been designated for being transported via the circuit switched circuit, the method further including the steps of:
converting the received packet switched data to at least one fixed length packet, each fixed length packet including a header and being of a length of one of the time slots;
transporting each fixed length packet from the input transitional switch to the output transitional switch on successive communications links, the successive communication links being selected based on comparing the header in each fixed length packet with the routing table in each of the core switches from which the successive communication link originates; and
consigning each fixed length packet on each of the successive communication links to at least one of the time slots which is not reserved to one of the circuit switched circuits.

19. The method according to claim 17, wherein if the received packet switched data have not been designated for being transported via the circuit switched circuit, the method further including the steps of:
converting the received packet switched data to at least one fixed length packet, each fixed length packet including a header and being of a length of one of the time slots;
transporting each fixed length packet from the input transitional switch to the output transitional switch on successive communications links, the successive communication links being selected based on comparing the header in each fixed length packet with the routing table in each of the core switches from which the successive communication link originates; and
consigning each fixed length packet on each of the successive communication links to at least one of the time slots which is reserved to one of the circuit switched circuits but which is empty.

20. The method according to claim 17, wherein if the received packet switched data have not been designated for being transported via the circuit switched circuit, the method further including the steps of:
converting the received packet switched data to at least one fixed length packet, each fixed length packet including a header and being of a length of one of the time slots;
transporting each fixed length packet from the input transitional switch to the output transitional switch on successive communications links, the successive communication links being selected based on comparing the header in each fixed length packet with the routing table in each of the core switches from which the successive communication link originates; and
consigning each fixed length packet to a first occurring empty time slot.

21. The method according to claim 17, wherein if the received packet switched data have been designated for being transported via the circuit switched circuit, the method further including the steps of:
converting the received packet switched data to at least one fixed length packet having a length corresponding to one of the time slots;
consigning each fixed length packet to one of the reserved time slots on each of the selected communication links;
interchanging the time slot allocated to each fixed length packet if there is contention for the time slot; and
transporting each fixed length packet along the circuit from the one input transitional switch to the one output transitional switch.
